(19) United States
(12) Patent Application Publication
(10) Pub. No.: US 2011/0280318 A1
(43) Pub. Date: Nov. 17, 2011

(54) MULTIVIEW VIDEO DECODING APPARATUS AND MULTIVIEW VIDEO DECODING METHOD

(75) Inventors: Takeshi YADO, Osaka (JP); Yuya SHIGENOBU, Nara (JP)

(73) Assignee: PANASONIC CORPORATION, Osaka (JP)

(21) Appl. No.: 13/191,799

(22) Filed: Jul. 27, 2011

Related U.S. Application Data
(63) Continuation of application No. PCT/JP2010/004484, filed on Jul. 9, 2010.

(30) Foreign Application Priority Data
Nov. 30, 2009 (JP) 2009-272839

(51) Int. Cl. H04N 7/26

(52) U.S. Cl. 375/240.25; 375/E07.027

(57) ABSTRACT

A multiview video decoding apparatus which sufficiently suppresses artifact in a decoded image even when an error occurs in the to-be-decoded image. It decodes a video stream including first coded video information of a first viewpoint and second coded video information of a second viewpoint, and includes: a decoding unit which decodes the video stream; and an error detecting unit which detects an error in the video stream; and an error concealing unit which conceals the error and includes (i) a decoding control unit which, when the error is in first coded image information in the first coded video information, causes said decoding unit to decode second coded image information included in the second coded video information and to be decoded after the first coded image information and (ii) a concealment processing unit which conceals the detected error, using decoded image information generated by decoding the second coded image information.

### CROSS REFERENCE TO RELATED APPLICATION

This is a continuation application of PCT application No. PCT/JP2010/004484 filed on Jul. 9, 2010, designating the United States of America.

### BACKGROUND OF THE INVENTION

(1) Field of the Invention

The present invention relates to a multiview video decoding apparatus which decodes a video stream including pieces of video information of plural viewpoints for stereoscopic views, and in particular to a multiview video decoding apparatus which decodes a video stream including a piece of video information of a viewpoint coded with reference to a piece of video information of another viewpoint.

(2) Description of the Related Arts

Coding techniques according to the MPEG (Moving Picture Experts Group) Standard(s) have been known as one type of techniques for compressing and coding video information. In recent years, MPEG-2, MPEG-4, and MPEG-4 AVC have been known as the principal widespread MPEG Standards.

One of the major features of these compression techniques is to code a difference between a picture as a coding target (hereinafter referred to as a current picture to be coded) and a picture that is already coded and reconstructed (hereinafter referred to as a reference picture). More specifically, the feature lies in performing Discrete Cosine Transform (DCT) on the difference between the current picture to be coded and the reference picture, and performs variable coding on the quantization result.

The following describes a case of decoding image data coded according to the aforementioned compressing and coding technique. For example, the image data coded according to MPEG-2 is composed of three kinds of pictures that are an I-picture, a P-picture, and a B-picture.

The I-picture is a picture coded without reference to any other picture. Accordingly, the I-picture can be decoded independently.

The P-picture is a picture to be coded with reference to a previous I-picture or P-picture and using the difference with the reference picture. Since the P-picture is decoded with reference to the previous I-picture or P-picture, the reference I-picture or P-picture must be decoded in advance.

The B-picture is a picture to be coded with reference to both a previous I-picture or P-picture and a following I-picture or P-picture and using the difference with the reference pictures. Since the B-picture is decoded with reference to the previous and following I-picture(s) and/or P-picture(s), the reference I-picture(s) and/or P-picture(s) must be decoded in advance.

Furthermore, recent years have seen a coding technique for coding video data of videos captured at plural viewpoints (multi-channel video data) based on the H.264/MVC Standard. The H.264/MVC Standard is intended to increase a compression rate by utilizing the correlation between plural video data. Since the plural video data are data obtained by capturing images of a subject from plural viewpoints, the plural video data has a feature of being similar to each other. By utilizing this feature, the H.264/MVC Standard allows the coding of the video data of a given channel with reference to video data of another channel. The H.264/MVC Standard is used in, for example, coding a three-dimensional video that can be perceived three-dimensionally by a viewer.

It is to be noted that, since there is a reference relationship between the multi-channel video data, in the case where an error is included in video data to be referred to from other video data, a right reference image cannot be obtained, disabling generation of an accurate decoded image. In this case, the resulting decoded image suffers from artifact. In particular, in the case of a multiview video composed of videos of plural channels, an unnatural three-dimensional video is displayed due to inclusion of such a decoded image including the artifact.

Patent Reference 1 (Japanese Patent No. 3992533 Publication) discloses a data decoding apparatus which conceals an error. When the data decoding apparatus disclosed in Patent Reference 1 detects an error in an input coded data, the data decoding apparatus conceals the error using one of: a first concealing unit which conceals an error using data of the channel at which the error has been detected; and a second concealing unit which conceals an error using data of a channel different from the channel at which the error has been detected.

Patent Reference 2 (Japanese Patent No. 3332575 Publication) also discloses a three-dimensional video reproducing apparatus which conceals an error if any. When the three-dimensional video reproducing apparatus disclosed in Patent Reference 2 detects an error in image data, the three-dimensional video reproducing apparatus uses complementary image data of another channel on a per image basis, instead of the error image data.

These techniques disclosed in Patent References 1 and 2 are features of MPEG coding techniques etc., and are error concealment techniques for replacing an error image that is an image including an error, utilizing an image that is likely to be referred to in a future decoding process.

### SUMMARY OF THE INVENTION

However, the aforementioned conventional techniques entail a problem of being impossible to sufficiently suppress artifact that caused by an error if any in a decoded image.

As described above, the techniques disclosed in Patent References 1 and 2 are intended to conceal a detected error using already-decoded image data. However, the already-decoded image data is not always the optimum replacement image for the error image.

For example, in the case of a three-dimensional video composed of left-eye images and right-eye images, a current left-eye image may be correlated with the right-eye image having the same time as the time of the current left-eye image more highly than the left-eye image immediately before or after the current left-eye image. In this case, in the case where an error is included in the current left-eye image, it is desirable that the same-time right-eye image is used to conceal the error. However, when the same-time right-eye image is decoded immediately after the current left-eye image, it is impossible to use the same-time right-eye image to conceal the error.

As described above, the conventional technique does not allow selection of more suitable image for error concealment, and thus cannot sufficiently suppress artifact in a resulting decoded image.

In view of this, the present invention has been conceived to solve the aforementioned problems. The present invention has an object to provide a multiview video decoding apparatus and a multiview video decoding method for enabling sufficient suppression of artifact in a decoded image even when an error is included.

In order to solve the aforementioned problems, the multiview video decoding apparatus decodes a video stream including first coded video information of a first viewpoint and second coded video information of a second viewpoint different from the first viewpoint, and includes: a decoding unit configured to decode the video stream; an error detecting unit configured to detect an error in the video stream; and an error concealing unit configured to conceal the error detected by the error detecting unit, wherein the error concealing unit includes: a decoding control unit configured, when the error detected by the error detecting unit is included in first coded image information in the first coded video information, to control the decoding unit such that the decoding unit decodes second coded image information included in the second coded video information, the second coded image information being scheduled to be decoded after the first coded image information is decoded; and a concealment processing unit configured to conceal the error detected by the error detecting unit, using decoded image information generated by the decoding of the second coded image information by the decoding unit.

In this way, the error is concealed using decoded image information that is not yet decoded according to a normal decoding order. This enables selection of more suitable image information, and thereby making it possible to sufficiently suppress artifact in the resulting decoded image.

In addition, the second coded video information may be coded with reference to the first coded video information, the error concealing unit may further include a determining unit configured to determine whether or not the second coded image information relates to an intra image or determine whether or not the second coded image information requires parallax compensation processing, when the detected error is included in the first coded image information, and the decoding control unit may be configured to control the decoding unit such that the decoding unit decodes the second coded image information, when the determining unit determines that the second coded image information relates to an intra image or determines that the second coded image information does not require parallax compensation processing.

This eliminates the possibility that the second coded image information is decoded with reference to the first coded image information including the error. Therefore, it is possible to decode the second coded image information accurately, and select more suitable image information.

In addition, the concealment processing unit may be configured to replace a result of decoding the first coded image information with first concealment image information that is decoded image information generated when the decoding unit decodes the second coded image information.

In addition, the second coded image information may be image information that is displayed at substantially a same time as a display time of the first coded image information.

In this case, since the same-time image information has a high correlation, it is possible to conceal the error using the highly-correlated image information.

In addition, the concealment processing unit may be configured to replace the result of decoding the first coded image information with second concealment image information that is decoded image information generated before the decoding of the first coded image information when the decoding unit decodes the first coded video information, when the determining unit determines that the second coded image information does not relate to an intra image or determines that the second coded image information requires the parallax compensation processing.

In this way, even when the second coded image information is decoded with reference to the first coded image information including the error, it is possible to conceal the error by replacing the result of decoding the first coded image information with the concealment image information.

In addition, the decoding control unit may be configured to control the decoding unit such that the decoding units decodes the second coded image information after the concealment processing unit conceals the error, when the determining unit determines that the second coded image information does not relate to an intra image or determines that the second coded image information requires the parallax compensation processing, the decoding unit may be configured to generate third concealment image information that is decoded image information by decoding the second coded image information under the control of the decoding control unit, the determining unit may be further configured to determine whether or not the decoding unit refers to the second concealment image information when the decoding unit generates the third concealment image information, and the concealment processing unit may be configured to replace the second concealment image information with the third concealment image information when the determining unit determines that the second concealment image information is not yet referred to.

In this way, after the second coded image information is decoded, it is possible to further replace the second concealment image information used to conceal the first coded image information including the error with the result of decoding the second coded image information. Since the second coded image information and the first coded image information are highly correlated with each other, it is possible to conceal the error using a more suitable image.

In addition, the concealment processing unit may be configured to generate fourth concealment image information by performing motion compensation processing using decoded image information generated when the decoding unit decodes the second coded image information, and replace a result of decoding the first coded image information with the fourth concealment image information.

In addition, the error concealing unit may be configured to conceal the error detected by the error detecting unit by replacing, in a processing unit smaller than a frame, image information including the error with predetermined image information.

In this way, it is possible to reduce the area of the image information to be replaced, and thereby making it possible to generate an error-concealed image that can be perceived as a less unnatural image.

It is to be noted that the present invention can be implemented not only as the multiview video decoding apparatus, but also as a method including the steps corresponding to the unique processing units of the multiview video decoding apparatus. Furthermore, the present invention can be implemented as a program causing a computer to execute these steps. Furthermore, the present invention can be implemented as a computer-readable recording medium such as a CD-ROM (Compact Disc-Read Only Memory) having the program recorded thereon, and as information, data or signals representing the program. Furthermore, these program, information, data and signals may be distributed via a communication network such as the Internet.

Some or all of the structural elements of the above-described multiview video decoding apparatus may be formed with a signal system LSI (Large Scale Integration). The system LSI is a super-multifunctional LSI manufactured by integrating plural structural elements on a single chip, and more specifically, a computer system configured to include a microprocessor, a ROM, a RAM (Random Access Memory), etc.

The multiview video decoding apparatus according to the present invention is capable of sufficiently suppressing artifact in a decoded image even when an error is included in the image to be decoded, and therefore it can provide a more natural image.

### Further Information about Technical Background to this Application

The disclosure of Japanese Patent Application No. 2009-272839 filed on Nov. 30, 2009 including the Specification, Drawings and Claims is incorporated herein by reference in its entirety.

This disclosure of PCT application No. PCT/JP2010/004484 filed on Jul. 9, 2010, including the Specification, Drawings and Claims is incorporated herein by reference in its entirety.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 is a block diagram showing an example of a structure of a multiview video decoding apparatus according to Embodiment 1;

FIG. 2 is a block diagram showing an example of a structure of an error image concealing unit according to Embodiment 1;

FIG. 3 is a diagram showing an example of a video stream composed of video information of two channels;

FIG. 4 is a flowchart indicating exemplary operations performed in the case where an error is included, among operations performed by the multiview video decoding apparatus according to Embodiment 1;

FIG. 5A is a schematic diagram showing an example of processes performed in the case where an error is included in a coded picture that is not referred to by another video information;

FIG. 5B is a schematic diagram showing an example of processes performed in the case where an error is included in a coded picture that is referred to by another video information;

FIG. 6 is a flowchart indicating exemplary operations performed in the case where an error is included, among operations performed by the multiview video decoding apparatus according to Embodiment 2; and

FIG. 7 is an external view showing examples of a digital television and a digital video recorder provided with a multiview video decoding apparatus according to the present invention.

### DESCRIPTION OF THE PREFERRED EMBODIMENTS

Hereinafter, embodiments of a multiview video decoding apparatus and a multiview video decoding method according to the present invention are described with reference to the drawings.

### Embodiment 1

A multiview video decoding apparatus according to Embodiment 1 decodes a video stream including first coded video information of a first viewpoint and second coded video information of a second viewpoint coded with reference to the first video information, and includes: a decoding unit configured to decode the video stream; an error detecting unit configured to detect an error in the video stream; and an error concealing unit configured to conceal the error detected by the error detecting unit, wherein the error concealing unit includes: a decoding control unit configured, when the error detected by the error detecting unit is included in first coded image information in the first coded video information, to control the decoding unit such that the decoding unit decodes second coded image information included in the second coded video information, the second coded image information being scheduled to be decoded after the first coded image information is decoded; and a concealment processing unit configured to conceal the error detected by the error detecting unit, using decoded image information generated by the decoding of the second coded image information by the decoding unit.

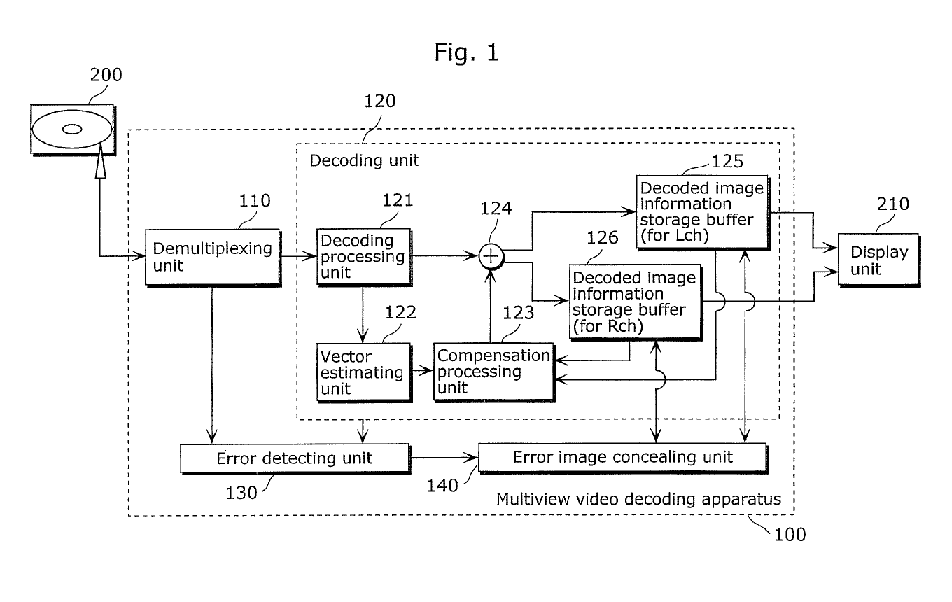

FIG. 1 is a block diagram showing an example of a structure of a multiview video decoding apparatus 100 according to Embodiment 1. The multiview video decoding apparatus 100 decodes a video stream including plural pieces of video information each of which corresponds to one of plural viewpoints. More specifically, the multiview video decoding apparatus 100 reads out the video stream from a recording medium 200, and decodes the read out video stream to generate decoded images. The generated decoded images are output to the display unit 210 and displayed.

The plural pieces of video information are, for example, pieces of video information generated by coding videos obtained by capturing images of a subject from mutually different viewpoints, according to a predetermined coding standard. More specifically, the plural pieces of video information are first video information of a first viewpoint and second video information of a second viewpoint. For example, the first video information and the second video information correspond to a left-eye video and a right-eye video which make up a three-dimensional video that can be three-dimensionally viewed by a viewer.

The predetermined coding standard is, for example, the H.264/MVC Standard. The second video information is coded with reference to the first video information. In other words, at least one piece of the plural coded image information included in the second video information is coded with reference to the first video information. More specifically, the first video information is video information of a base view, and the second video information is video information of a dependent view.

The video information of the base view is video information that is coded independently without reference to video information of another viewpoint and is referred to in coding of video information of another viewpoint. The video information of the dependent view is video information that is coded with reference to another piece of video information.

Hereinafter, as an example, a description is given of a case where a video stream includes video information of a left-eye channel (Lch) corresponding to a left-eye video, and video information of a right-eye channel (Rch) corresponding to a right-eye video. Furthermore, it is assumed that the Lch video information is the video information of the base view, and that the Rch video information is the video information of the dependent view. Alternatively, it is possible that the Lch video information is the video information of the dependent view, and that the Rch video information is the video information of the base view.

As shown in FIG. 1, the multiview video decoding apparatus 100 includes a demultiplexing unit 110, a decoding unit 120, an error detecting unit 130, and an error image concealing unit 140.

The demultiplexing unit 110 demultiplexes the video stream into coded video information and the other information. The coded video information includes, for example, coded image information generated by coding images included in video data based on the H.264/MVC Standard etc. The demultiplexed video information is output to the decoding unit 120.

Here, the other information is, for example, audio data and user data included in the video stream. The other information such as the audio data and the user data do not particularly relate to the features of the present invention, and thus no descriptions thereof are given here.

The demultiplexing unit 110 reads out a video stream from a recording medium 200, and demultiplexes the read-out video stream, for example. Furthermore, the demultiplexing unit 110 demultiplexes the coded video information into pieces of video information for the respective channels. More specifically, since the video stream includes Lch video information and Rch video information, the demultiplexing unit 110 demultiplexes the video stream into the Lch video information and the Rch video information. The video information of each channel includes pieces of coded image information. For example, the pieces of coded image information are sequentially output to the decoding unit 120 on a per picture basis.

The recording medium 200 is a recording medium on which the video stream is recorded, and is, for example, an optical disc such as a DVD (Digital Versatile Disc) or a BD (Blu-ray Disc). In addition, the recoding medium 200 may be a magnetic disc such as an HDD (Hard Disk Drive) or a semiconductor memory.

The decoding unit 120 sequentially decodes the pieces of coded image information input from the demultiplexing unit 110. As shown in FIG. 1, the decoding unit 120 includes a decoding processing unit 121, a vector estimating unit 122, a compensation processing unit 123, a decoded image information generating unit 124, and decoded image information storage buffers 125 and 126.

The decoding processing unit 121 decodes input coded image information. The coded image information is image data coded based on the H.264/MVC Standard. More specifically, the coded image information is image data generated by coding difference information that relates to a difference between a current image and a reference image and control information required for decoding processing, such as identification information of a reference picture.

The decoding processing unit 121 generates the difference information and control information by decoding the coded image information. The generated difference information is output to the decoded image information generating unit 124. The generated control information is output to the vector estimating unit 122.

The vector estimating unit 122 estimates a motion vector or a parallax vector based on input control information. The estimated motion vector or parallax vector is output to the compensation processing unit 123.

The compensation processing unit 123 generates motion-compensated image information and parallax-compensated image information with reference to decoded image information stored in one of the decoded image information storage buffers 125 and 126, based on the input motion vector or parallax vector. The generated motion-compensated image or parallax-compensated image is output to the decoded image information generating unit 124.

The decoded image information generating unit 124 generates decoded image information by adding the difference information input from the decoding processing unit 121 and the motion-compensated image information or parallax-compensated image information input from the compensation processing unit 123. The generated decoded image information is stored into one of the decoded image information storage buffers 125 and 126. More specifically, the decoded image information generating unit 124 stores the decoded image information into the decoded image information storage buffer 125 when the generated decoded image information is Lch image information. On the other hand, the decoded image information generating unit 124 stores the decoded image information into the decoded image information storage buffer 126 when the generated decoded image information is Rch image information.

The decoded image information storage buffer 125 is a buffer memory for storing the Lch decoded image information.

The decoded image information storage buffer 126 is a buffer memory for storing the Rch decoded image information. It is to be noted that the decoded image information storage buffers 125 and 126 may be two physically different buffer memories, or memory areas that are segments logically divided within a physically one buffer memory.

The error detecting unit 130 detects an error in the video stream. More specifically, the error detecting unit 130 detects the error by monitoring the operation state of either the demultiplexing unit 110 or the decoding unit 120. More specifically, if the demultiplexing unit 110 does not successfully read out a video stream from the recording medium 200, and particularly, if the read-out video stream is partly lost, the error detecting unit 130 detects that an error is included, and notifies the error image concealing unit 140 of the detection of the error. Alternatively, when the decoding processing unit 121 does not successfully decode the coded image information, for example, when the code of the coded image information does not conform to the standard in use, the error detecting unit 130 detects that an error is included, and notifies the error image concealing unit 140 of the detection of the error.

The error image concealing unit 140 conceals the error when the error is detected by the error detecting unit 130. More specifically, the error image concealing unit 140 conceals the error by identifying the image including the error (hereinafter referred to as error image information) and replacing the identified error image information with a predetermined image (hereinafter referred to as concealment image information).

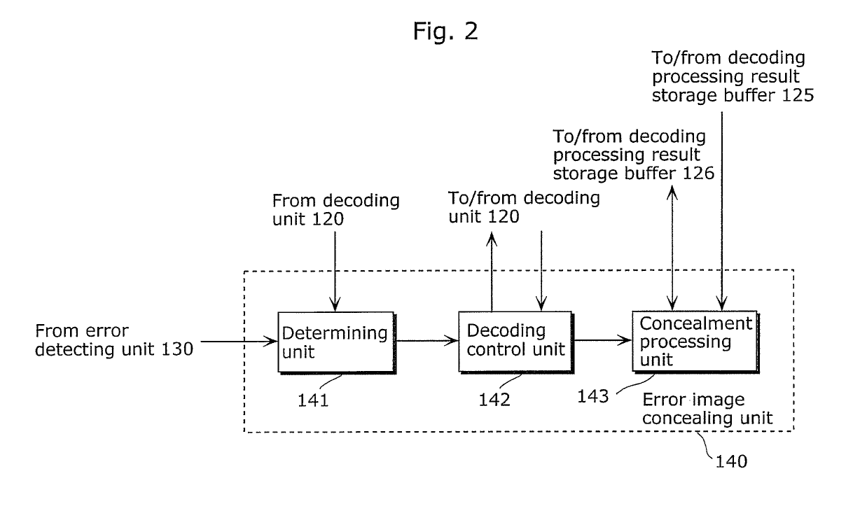

FIG. 2 is a block diagram showing an example of a structure of an error image concealing unit 140 according to Embodiment 1. As shown in FIG. 2, the error image concealing unit 140 includes a determining unit 141, a decoding control unit 142, and a concealment processing unit 143.

The determining unit 141 determines which one of the first video information and the second video information includes the error. In other words, the determining unit 141 determines which one of the video information of the base view and the video information of the dependent view includes the error.

Furthermore, when the detected error is included in the first video information, the determining unit 141 determines whether or not second coded image information included in the second video information relates to an intra image or determines whether or not the second coded image information requires parallax compensation processing. Here, the second coded image information is information scheduled to be decoded after the first coded image information including the detected error is decoded. More specifically, when the detected error is included in the video information of the base view, the determining unit 141 determines whether or not a second coded picture included in the video information of the dependent view is decoded with reference to a first coded picture including the error. Here, the second coded picture is the picture scheduled to be decoded next to the first coded picture including the detected error.

After a result of decoding the first coded image information including the error is replaced with the predetermined concealment image information, the decoding unit 120 decodes the second coded image information to generate decoded image information. The determining unit 141 further determines whether or not the decoding unit 120 actually refers to the replaced concealment image information in the generation of the decoded image information. More specifically, the determining unit 141 determines whether or not the decoding unit 120 actually refers, when decoding the second coded picture, to the error image information included in the decoded picture generated by decoding the first coded picture including the error.

When the error detecting unit 130 detects the error in the first coded image information, the decoding control unit 142 controls the decoding unit 120 such that the decoding unit 120 decodes the second coded image information scheduled to be decoded after the decoding of the first coded image information.

More specifically, when the determining unit 141 determines that the second coded image information relates to an intra image, or determines that the second coded image information does not require parallax compensation processing, the decoding control unit 142 controls the decoding unit 120 such that the decoding unit 120 decodes the second coded image information. In other words, the decoding control unit 142 causes the decoding unit 120 to decode the second coded picture included in the video information of the dependent view scheduled to be decoded next to the first coded picture including the error in the video image information of the base view.

Furthermore, when the determining unit 141 determines that the second coded image information does not relate to an intra image, or determines that the second coded image information requires parallax compensation processing, the decoding control unit 142 controls the decoding unit 120 such that the decoding unit 120 decodes the second coded image information after the concealment processing unit 143 conceals the error. In other words, when the second coded picture included in the video information of the dependent view scheduled to be decoded next requires parallax compensation processing, the decoding control unit 142 causes the decoding unit 120 to decode the second coded picture of the dependent view after the error image information included in the result of decoding the first coded picture including the error of the base view is replaced with the concealment image information.

The concealment processing unit 143 conceals the error detected by the error detecting unit 130 using the decoded image information generated when the decoding unit 120 decodes the second video information. More specifically, the concealment processing unit 143 generates first concealment image information using the second decoded image information generated when the decoding unit 120 decodes the second coded image information. Furthermore, the concealment processing unit 143 conceals the error by replacing the result of decoding the first coded image information with the first concealment image information.

For example, when the detected error is included in the first coded picture of the base view, the concealment processing unit 143 generates the first concealment image information using the result of decoding the second coded picture of the dependent view. For example, the concealment processing unit 143 generates the first concealment image information by obtaining the second decoded image information that is the result of decoding the second coded picture. Next, the concealment processing unit 143 replaces the error image information included in the result of decoding the first coded picture with the generated first concealment image information.

In addition, when the determining unit 141 determines that the second coded image information does not relate to an intra image, or determines that the second coded image information requires parallax compensation processing, the concealment processing unit 143 replaces the result of decoding the first coded image information with the second concealment image information that is decoded image information generated when the decoding unit decodes the first video information before decoding the first coded image information including the error.

More specifically, when the second coded picture scheduled to be decoded next to the first coded picture including the error refers to the first coded picture, the concealment processing unit 143 generates the second concealment image information by obtaining the decoded image information decoded before the first coded image information of the base view is decoded. In other words, the concealment processing unit 143 generates the second concealment image information using coded image information that is of the channel where the error is included and has a time identical to or different from the time of the coded image information including the error.

Furthermore, after the result of decoding the first coded image information is replaced with the second concealment image information due to the occurrence of the error, the concealment processing unit 143 replaces the second concealment image information with the third concealment image information generated when the decoding unit 120 decodes the second coded image information. More specifically, when the determining unit 141 determines that the second concealment image information is not yet referred to in the generation of the third concealment image information, the concealment processing unit 143 replaces the second concealment image information with the third concealment image information.

The second coded image information is image information that is decoded, and then displayed at substantially a same time as a display time of the first coded image information, and thus the second coded image information has a high correlation with the first coded image information. Accordingly, it is preferable that, when the detected error is included in the first coded image information, the first coded image information be replaced with the result of decoding the second coded image information.

Since the concealment processing unit 143 replaces the second coded image information with the more preferable third concealment image information after the first coded image information is replaced with the second concealment image information as described above, the concealment processing unit 143 can sufficiently suppress the artifact in the resulting decoded image.

Although an exemplary embodiment of the multiview video decoding apparatus 100 according to Embodiment 1 is described above, the multiview video decoding apparatus 100 may be configured to perform an arbitrarily added process such as an in-loop filtering process.

When only a video stream is input, or when there is no need to demultiplex pieces of video information, the multiview video decoding apparatus 100 does not necessarily need to include the demultiplexing unit 110.

In this embodiment, the multiview video decoding apparatus 100 is configured to include a single decoding processing unit 121, but the multiview video decoding apparatus 100 may include, for each channel, a decoding processing unit, a vector estimating unit, and a compensation processing unit.

Alternatively, the multiview video decoding apparatus 100 may include, instead of a vector estimating unit 122, a motion vector estimating unit which estimates motion vectors for use in motion compensation processing and a parallax vector estimating unit which estimates parallax vectors for use in parallax compensation processing. Likewise, the multiview video decoding apparatus 100 may include, instead of the compensation processing unit 123, a motion compensation unit which performs motion compensation processing and a parallax compensation unit which performs parallax compensation processing.

The multiview video decoding apparatus 100 reads out a video stream from the recording medium 200 in this embodiment, but the multiview video decoding apparatus 100 may obtain a video stream, for example, via a network or a broadcast wave.

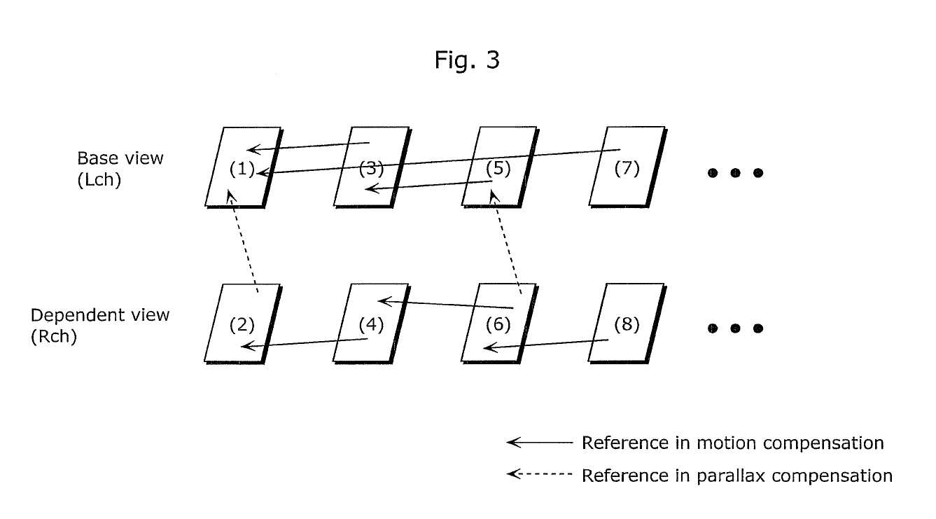

FIG. 3 is a diagram showing an example of a video stream composed of video information of two channels. As shown in FIG. 3, the Lch video information is the base view, and the Rch video information is the dependent view. In other words, the Lch video information is referred to in the decoding of the Rch video information.

When the decoding unit 120 decodes the video stream, as shown in FIG. 3, the decoding unit 120 alternately decodes, in units of a picture, the pieces of Lch coded image information and the pieces of Rch coded image information. In FIG. 3, each of parallelograms represents a picture, and the numbers written inside the respective pictures denote the decoding order.

In the motion compensation, already-decoded image information of the identical channel is referred to. For example, as shown in FIG. 3, Picture 1 is referred to when the picture 3 of the base view is decoded.

In the parallax compensation, already-decoded image information of the other channel is referred to. For example, as shown in FIG. 3, Picture 5 is referred to when Picture 6 of the dependent view is decoded.

Here, Pictures 1 and 2, and also Pictures 3 and 4 are pictures scheduled to be displayed at the same time (same-time pictures). In other words, Picture 1 that is a left-eye image and Picture 2 that is a right-eye image are paired with each other to make up a three-dimensional image that can be three-dimensionally recognized by the viewer. As shown in FIG. 3, the multiview video decoding apparatus 100 decodes, among the pair, the picture of the base view first, and then decode the picture of the dependent view.

The following description is given of the multiview video decoding apparatus 100 according to Embodiment 1. Particularly, the following description is given of operations performed in the case where an error is included. It is to be noted that the multiview video decoding apparatus 100 performs decoding according to the H.264/MVC Standard in the case where no error is included, and thus no descriptions for such a case is given here.

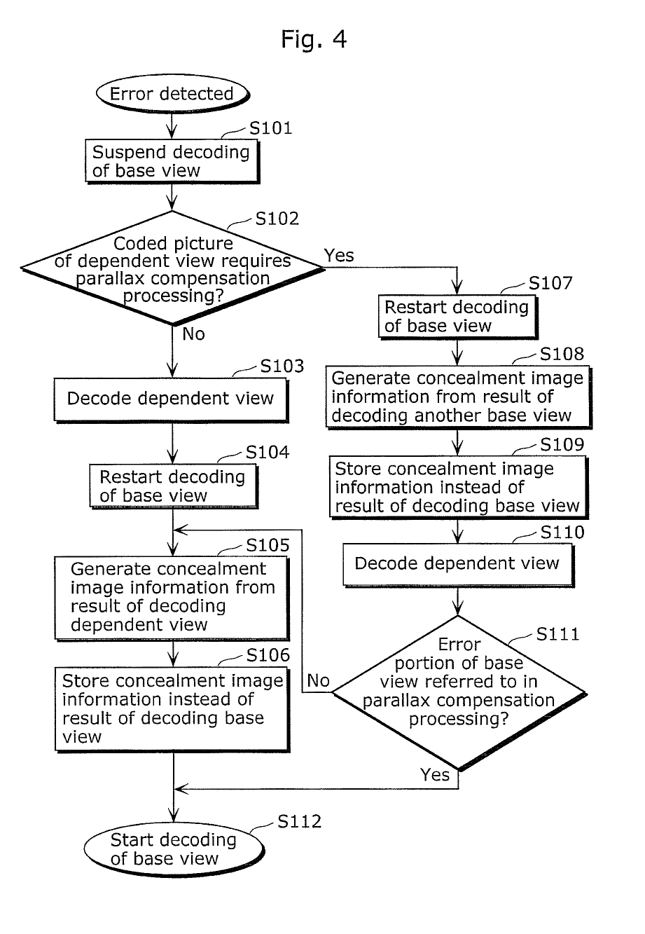

FIG. 4 is a flowchart indicating exemplary operations performed in the case where an error is included, among operations performed by the multiview video decoding apparatus 100 according to Embodiment 1.

When the error detecting unit 130 detects an error in the video information of the base view, the error image concealing unit 140 suspends the decoding of a current coded picture to be decoded of the base view, based on an error notification from the error detecting unit 130 (S101). For example, when the error is included in Picture 5 as shown in FIG. 3, the error image concealing unit 140 suspends the decoding of Picture 5.

The determining unit 141 determines whether or not a current coded picture that is of the dependent view and is scheduled to be decoded next to the coded picture for which the decoding is suspended requires parallax compensation processing (S102). For example, when the error is included in Picture 5 as shown in FIG. 3, the determining unit 141 determines whether or not Picture 6 relates to an intra picture, or determines whether or not Picture 6 requires parallax compensation processing. When the current coded picture of the dependent view is an intra picture, the coded picture is decoded without reference to another picture, and thus does not require parallax compensation processing.

When the current coded picture of the dependent view does not require parallax compensation processing (No in S102), the decoding unit 120 decodes the dependent view under control of the decoding control unit 142 (S103).

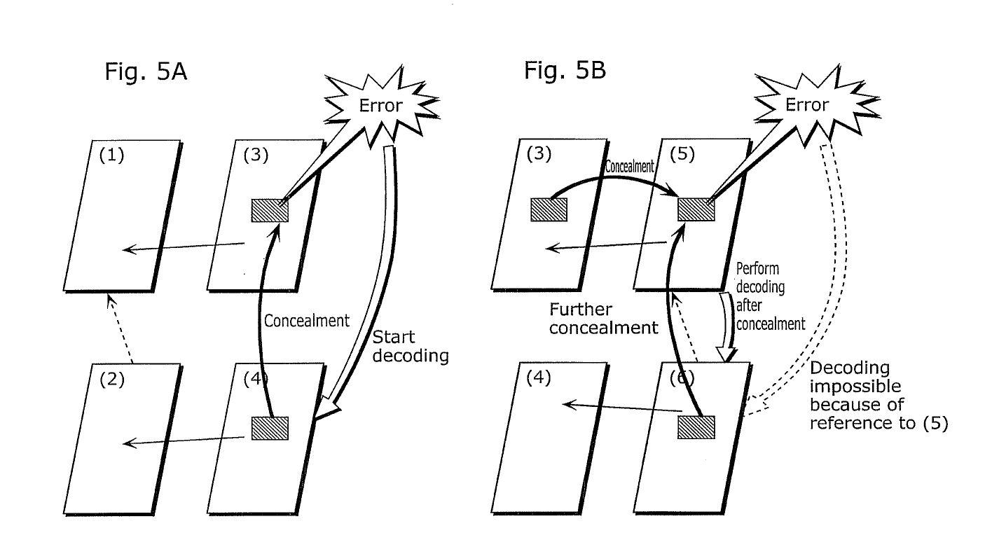

For example, as shown in FIG. 5A, when Picture 3 includes an error, Picture 4 scheduled to be decoded next does not require parallax compensation processing. For this reason, the decoding control unit 142 controls the decoding unit 120 such that the decoding unit 120 decodes Picture 4. Since Picture 4 does not refer to Picture 3 including the error, the decoding unit 120 can correctly decode Picture 4 without being affected by the error.

Upon completion of the decoding of the coded picture of the dependent view, the decoding control unit 142 restarts the decoding of the coded picture of the base view (S104). For example, when the decoding control unit 142 receives, from the decoding unit 120, a completion notification indicating the completion of the decoding of the coded picture of the dependent view, the decoding control unit 142 restarts the decoding of the coded picture of the base view.

At this time, the decoding unit 120 may decode the coded picture including the error from the starting point, or may decode the coded picture from the portion as a decoding suspension point. For example, when the decoding of Picture 4 as shown in FIG. 5A is completed, the decoding control unit 142 restarts the decoding of Picture 3 including the error.

The concealment processing unit 143 generates first concealment image information by obtaining the result of decoding the coded picture of the dependent view (S105). More specifically, the concealment processing unit 143 generates the first concealment image information by performing, for example, parallax compensation processing using the coded image information of the dependent view that is displayed at substantially a same time as a display time of the coded image information of the base view including the error. For example, when Picture 3 as shown in FIG. 5A includes the error, the concealment processing unit 143 generates first concealment image information by obtaining the result of decoding Picture 4 having the same time as the time of Picture 3.

Next, the concealment processing unit 143 stores the first concealment image information into the decoded image information storage buffer 125, instead of the result of decoding the coded image information of the base view (S106). In other words, the concealment processing unit 143 replaces the result of decoding the coded image information of the base view with the first concealment image information. At this time, it is only necessary for the concealment processing unit 143 to replace only the image including the error among the coded pictures of the base view. In particular, the concealment processing unit 143 may replace the image information including the error with a predetermined image information, in units of a processing unit smaller than a frame. In other words, the concealment processing unit 143 does not need to replace the whole image information of a frame or a picture, and is only required to replace data corresponding to a slice or a macroblock including the error.

When the decoding of the coded picture including the error is completed after the completion of the error concealment, the decoding unit 120 starts the decoding of the next coded picture of the base view (S112). In the example as shown in FIG. 5A, when the error concealment and the decoding on Picture 3 are completed, the decoding unit 120 starts decoding of Picture 5.

When the coded picture of the dependent view requires parallax compensation processing (Yes in S102), the decoding unit 120 restarts the decoding of the base view under control of the decoding control unit 142 (S107). For example, as shown in FIG. 5B, when Picture 5 includes an error, Picture 6 scheduled to be decoded next requires parallax compensation processing. In other words, in order to decode Picture 6, the result of decoding Picture 5 must be already obtained.

Accordingly, the concealment processing unit 143 generates second concealment image information using a result of decoding a picture, that is, already decoded picture of the base view. For example, the concealment processing unit 143 generates the second concealment image information by obtaining either decoded image information of the picture that is temporally closest to the coded picture including the error or decoded image information of a different area within the identical picture. In the example as shown in FIG. 5B, when Picture 5 includes an error, the concealment processing unit 143 generates second concealment image information by obtaining the result of decoding Picture 3.

Next, the concealment processing unit 143 stores the second concealment image information into the decoded image information storage buffer 125, instead of the result of decoding the coded image information including the error of the base view (S109). For example, in the example as shown in FIG. 5B, the concealment processing unit 143 obtains the result of decoding Picture 3 instead of the result of decoding Picture 5, and stores the obtained decoding result as second concealment image information into the decoded image information storage buffer 125.

Next, the decoding unit 120 decodes the coded picture that is of the dependent view and is scheduled to be decoded next to the coded picture including the error (S110). More specifically, as shown in FIG. 5B, the decoding unit 120 decodes Picture 6 under control of the decoding control unit 142 (S110). At this time, the decoding unit 120 decodes Picture 6 with parallax compensation processing with reference to the result of decoding Picture 5 (including the second concealment image information).

More specifically, the determining unit 141 determines whether or not the error portion is actually referred to in the parallax compensation processing in the decoding of the coded picture of the dependent view by the decoding unit 120 (S111). In the example as shown in FIG. 5B, the determining unit 141 determines whether or not the error portion that is of Picture 5 and is the second concealment image information as the replacement is referred to in the decoding of Picture 6. This determination is made because the whole Picture 5 is not necessarily replaced with the second concealment image information in the error concealment, and the error portion may not actually be referred to in the decoding of Picture 6.

When the error portion is not actually referred to (No in S111), the concealment processing unit 143 generates third concealment image information by obtaining the result of decoding the coded picture of the dependent view (S105), and stores the third concealment image information into the decoded image information storage buffer 125 (S106). In other words, in the example as shown in FIG. 5B, the concealment processing unit 143 obtains the result of decoding Picture 6 (third concealment image information), and replaces the second concealment image information that is the replacement as the result of decoding Picture 5 with the obtained result of decoding Picture 6.

Picture 6 is a same-time picture with respect to Picture 5, and thus is highly likely to have a higher correlation than Picture 3. Accordingly, the third concealment image information obtained from Picture 6 is more appropriate as the replacement for the result of decoding Picture 5, than the second concealment image information obtained from Picture 3. Since the result of decoding Picture 6 is not affected by the error (because the answer in S111 is No), it is possible to replace the result of decoding Picture 5 (the second concealment image information) with the result of decoding Picture 6 (the third concealment image information).

When the error portion is actually referred to (Yes in S111), the decoding of the next coded picture of the base view is started (S112).

When the detected error is included in the video information of the dependent view, since the paired base view is already decoded, the concealment processing unit 143 conceals the error using the result of decoding the paired base view. For example, when Picture 2 as shown in FIG. 3 includes an error, the concealment processing unit 143 stores the result of decoding Picture 1 as concealment image information into the decoded image information storage buffer 126.

As described above, when the first video information referred to in the decoding of the second video information includes an error, the multiview video decoding apparatus 100 according to Embodiment 1 decodes the second video information first, and conceals the error included in the first video information using the result of the decoding. More specifically, when the detected error is included in the first coded picture of the base view, the multiview video decoding apparatus 100 decodes the second coded picture of the dependent view first. The second coded picture is the same-time coded picture with respect to the first coded picture, and thus has a higher correlation with the first coded picture than the other coded pictures of the base view.

Accordingly, it is possible to perform error concealment processing with higher accuracy than conventional by concealing the error included in the first coded picture using the result of decoding the second coded picture, and thereby making it possible to sufficiently suppress artifact in the resulting decoded image.

### Embodiment 2

In the case where an error is included in video information to be referred to from other video information, a multiview video decoding apparatus according to Embodiment 2 of the present invention is intended to decode the other video information, and perform motion compensation processing on the result of decoding to generate concealment image information, and replace the error image information with the generated concealment image information.

Here, the multiview video decoding apparatus according to Embodiment 2 is configured to have the same structure as that of the multiview video decoding apparatus 100 according to Embodiment 1 as shown in FIG. 1. Thus, no description thereof is repeated.

The following description is given of the multiview video decoding apparatus according to Embodiment 2.

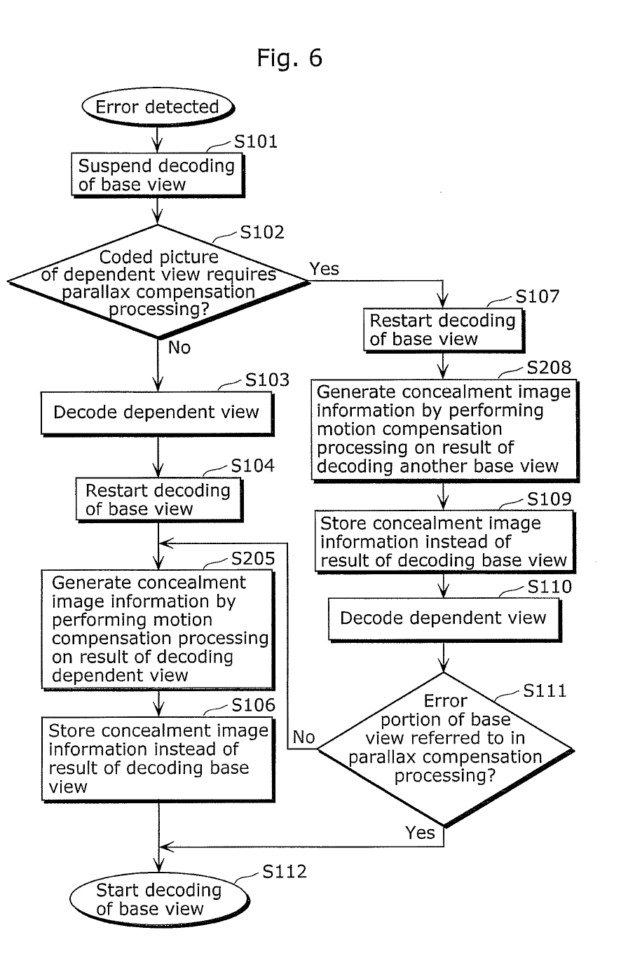

FIG. 6 is a flowchart indicating exemplary operations performed in the case where an error is included, among operations performed by the multiview video decoding apparatus according to Embodiment 2. Here, the same operations as those performed by the multiview video decoding apparatus 100 according to Embodiment 1 as shown in FIG. 4 are assigned with the same reference signs, and no descriptions thereof are repeated.

When a determining unit 141 determines that a coded picture that is of a dependent view and is scheduled to be decoded next to a coded picture including an error of a base view does not require parallax compensation processing (No in S102), a decoding unit 120 decodes the coded picture of the dependent view under control of a decoding control unit 142 (S103). Next, the decoding control unit 142 restarts the decoding of the coded picture including the error of the base view (S104).

A concealment processing unit 143 generates fourth concealment image information by obtaining the result of decoding the coded picture of the dependent view and performs motion compensation processing on the obtained decoding result (S205). The subsequent processes are performed in the same manner as Embodiment 1.

On the other hand, when the determining unit 141 determines that a coded picture that is of a dependent view and is scheduled to be decoded next to a coded picture including an error of a base view requires parallax compensation processing (Yes in S102), the decoding unit 120 restarts the decoding of the base view under control of the decoding control unit 142 (S107).

Next, the concealment processing unit 143 obtains a result of decoding a picture, that is, already decoded picture of the base view, and performs motion compensation processing on the obtained decoding result to generate second concealment image information (S208). The subsequent processes are performed in the same manner as Embodiment 1.

As shown above, in Embodiment 1, the result of decoding either a dependent view or a base view is directly used as concealment image information. However, in Embodiment 2, the result of decoding either a dependent view or a base view is used as image information for motion compensation.

As described above, in the case where an error is included in first video information that is referred to in the decoding of second video information, the multiview video decoding apparatus according to Embodiment 2 decodes the second video information first, and performs motion compensation processing on the result of decoding to generate concealment image information, and replaces the error image with the generated concealment image information. More specifically, when the detected error is included in the first coded picture of the base view, the multiview video decoding apparatus decodes the second coded picture of the dependent view first. The second coded picture is the same-time coded picture with respect to the first coded picture, and thus has a higher correlation with the first coded picture than the other coded pictures of the base view.

Accordingly, it is possible to generate concealment image information by performing motion compensation processing on the result of decoding the second coded picture, and replace the error image with the generated concealment image information. Therefore, it is possible to perform error concealment processing with higher accuracy than conventional, and thereby making it possible to sufficiently suppress artifact in the resulting decoded image.

It is to be noted that the concealment processing unit 143 may perform parallax compensation process on the result of decoding the base view when generating the concealment image information, in addition to performing the motion compensation process. Alternatively, these motion compensation process and parallax compensation process may be performed by either the concealment processing unit 143 inside the error image concealing unit 140 or the compensation processing unit 123 of the decoding unit 120.

Although the multiview video decoding apparatus and the multiview video decoding method according to the present invention are described above based on the above exemplary embodiments, the present invention is not limited to these embodiments. Those skilled in the art will readily appreciate that many modifications are possible in the exemplary embodiments and other embodiments are possible by arbitrarily combining the structural elements of the embodiments without materially departing from the novel teachings and advantageous effects of the present invention. Accordingly, all of the modifications and other embodiments are intended to be included within the scope of the present invention.

For example, although the above descriptions are given of taking an example of two pieces of video information one of which is of a base view and the other is of a dependent view, the multiview video decoding apparatus according to the present invention may decode three pieces of video information. Here is given an exemplary case where a video stream including video information of a single base view and video information of two dependent views is decoded, and an error is included in the video information of the base view in the decoding of the video stream. In this case, it is only necessary for the multiview video decoding apparatus to generate concealment image information using one of the two dependent views and replace the error image information with the concealment image information to conceal the error.

Likewise, in the case where an error is included in one of the dependent views, the error image concealing unit 140 may conceal the error image information using the result of decoding either the base view or the other dependent view. For example, when Picture 6 as shown in FIG. 3 includes the error, it is only necessary for the error image concealing unit 140 to use the result of decoding Picture 5 as the concealment image information.

Alternatively, the error image concealing unit 140 may control the decoding unit 120 so that the decoding unit 120 decodes picture 7 scheduled to be decoded next to Picture 6, and may use the result of decoding Picture 7 as the concealment image information. In this way, when the detected error is included in the coded image information of the dependent view, it is possible to decode the coded image information included in the base view scheduled to be decoded next to the coded image information including the error, and conceal the error using the decoding result.

In this way, for example, even if it is undesirable that the result of decoding Picture 5 is used as the concealment image information in an exemplary case where Picture 5 that is the same-time picture with respect to Picture 6 also includes an error, it is possible to conceal the error in Picture 6.

In addition, in Embodiment 1, the concealment processing unit 143 may generate the first concealment image information by performing parallax compensation process on the obtained second decoded image information.

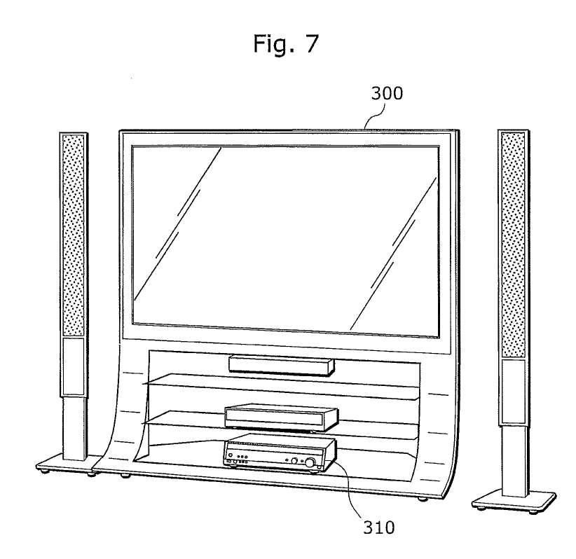

It is to be noted that the multiview video decoding apparatus according to the present invention is mounted on either a digital television set 300 as shown in FIG. 7, or a digital video recorder/player 310.

It is to be noted that the present invention can be implemented not only as the multiview video decoding apparatus and the multiview video decoding method as described above, but also as a program causing a computer to execute the multiveiw video decoding method according to any one of the embodiments. Furthermore, the program may be implemented as a recording medium such as a computer-readable CD-ROM having the program recorded thereon. Furthermore, the program may be implemented as information, data, or signals representing the program. In addition, these program, information, data, and signals may be distributed via a communication network such as the Internet.

In addition, some or all of the structural elements of the multiview video decoding apparatus according to the present invention may be implemented in the form of a single system LSI. The system LSI is a super-multifunctional LSI manufactured by integrating plural structural elements on a single chip, and more specifically, a computer system configured to include a microprocessor, a ROM, a RAM, etc.

### INDUSTRIAL APPLICABILITY

A multiview video decoding apparatus and a multiview video decoding method according to the present invention provide an advantageous effect of sufficiently suppressing artifact in a decoded image even when an error is included in the image to be decoded. The multiview video decoding apparatus and the multiview video decoding method can be used for digital apparatuses such as digital television sets, and DVD and BD recorders/players.

What is claimed is:

1. A multiview video decoding apparatus which decodes a video stream including first coded video information of a first viewpoint and second coded video information of a second viewpoint different from the first viewpoint, said multiview video decoding apparatus comprising:
a decoding unit configured to decode the video stream;
an error detecting unit configured to detect an error in the video stream; and
an error concealing unit configured to conceal the error detected by said error detecting unit,
wherein said error concealing unit includes:
a decoding control unit configured, when the error detected by said error detecting unit is included in first coded image information in the first coded video information, to control said decoding unit such that said decoding unit decodes second coded image information included in the second coded video information, the second coded image information being scheduled to be decoded after the first coded image information is decoded; and
a concealment processing unit configured to conceal the error detected by said error detecting unit, using decoded image information generated by the decoding of the second coded image information by said decoding unit.

2. The multiview video decoding apparatus according to claim 1,
wherein the second coded video information is coded with reference to the first coded video information,
said error concealing unit further includes
a determining unit configured to determine whether or not the second coded image information relates to an intra image or determine whether or not the second coded image information requires parallax compensation processing, when the detected error is included in the first coded image information, and
said decoding control unit is configured to control said decoding unit such that said decoding unit decodes the second coded image information, when said determining unit determines that the second coded image information relates to an intra image or determines that the second coded image information does not require parallax compensation processing.

3. The multiview video decoding apparatus according to claim 2,
wherein said concealment processing unit is configured to replace a result of decoding the first coded image information with first concealment image information that is decoded image information generated when said decoding unit decodes the second coded image information.

4. The multiview video decoding apparatus according to claim 3,
wherein the second coded image information is image information that is displayed at substantially a same time as a display time of the first coded image information.

5. The multiview video decoding apparatus according to claim 3,
wherein said concealment processing unit is configured to replace the result of decoding the first coded image information with second concealment image information that is decoded image information generated before the decoding of the first coded image information when said decoding unit decodes the first coded video information, when said determining unit determines that the second coded image information does not relate to an intra image or determines that the second coded image information requires the parallax compensation processing.

6. The multiview video decoding apparatus according to claim 5,
wherein said decoding control unit is configured to control said decoding unit such that said decoding units decodes the second coded image information after said concealment processing unit conceals the error, when said determining unit determines that the second coded image information does not relate to an intra image or determines that the second coded image information requires the parallax compensation processing,
said decoding unit is configured to generate third concealment image information that is decoded image information by decoding the second coded image information under the control of said decoding control unit,
said determining unit is further configured to determine whether or not said decoding unit refers to the second concealment image information when said decoding unit generates the third concealment image information, and
said concealment processing unit is configured to replace the second concealment image information with the third concealment image information when said determining unit determines that the second concealment image information is not yet referred to.

7. The multiview video decoding apparatus according to claim 2,
wherein said concealment processing unit is configured to generate fourth concealment image information by performing motion compensation processing using decoded image information generated when said decoding unit decodes the second coded image information, and replace a result of decoding the first coded image information with the fourth concealment image information.

8. The multiview video decoding apparatus according to claim 1,
wherein said error concealing unit is configured to conceal the error detected by said error detecting unit by replacing, in a processing unit smaller than a frame, image information including the error with predetermined image information.

9. A multiview video decoding method of decoding a video stream including first coded video information of a first viewpoint and second coded video information of a second viewpoint different from the first viewpoint, said multiview video decoding method comprising:
decoding the video stream;
detecting an error in the video stream; and
concealing the error detected in said detecting,
wherein, in said decoding,
second coded image information included in the second coded video information is decoded when the error detected in said detecting is included in first coded image information in the first coded video information, the second coded image information being scheduled to be decoded after the first coded image information is decoded, and
in said concealing,
the error detected in said detecting is concealed using decoded image information generated by decoding the second coded image information.

10. A non-transitory computer-readable recording medium for a computer, said recording medium having a program recorded thereon, is the program causing a computer to execute a multiview video decoding method of decoding a video stream including first coded video information of a first viewpoint and second coded video information of a second viewpoint different from the first viewpoint, and the multiview video decoding method including:
decoding the video stream;
detecting an error in the video stream; and
concealing the error detected in the detecting,
wherein, in the decoding,
second coded image information included in the second coded video information is decoded when the error detected in the detecting is included in first coded image information in the first coded video information, the second coded image information being scheduled to be decoded after the first coded image information is decoded, and
in the concealing,
the error detected in the detecting is concealed using decoded image information generated by decoding the second coded image information.

11. An integrated circuit which decodes a video stream including first coded video information of a first viewpoint and second coded video information of a second viewpoint different from the first viewpoint, said integrated circuit comprising:
a decoding unit configured to decode the video stream;
an error detecting unit configured to detect an error in the video stream; and
an error concealing unit configured to conceal the error detected by said error detecting unit,
wherein said error concealing unit includes:
a decoding control unit configured, when the error detected by said error detecting unit is included in first coded image information in the first coded video information, to control said decoding unit such that said decoding unit decodes second coded image information included in the second coded video information, the second coded image information being scheduled to be decoded after the first coded image information is decoded; and
a concealment processing unit configured to conceal the error detected by said error detecting unit, using decoded image information generated by the decoding of the second coded image information by said decoding unit.
